(19) United States
(12) Patent Application Publication
(10) Pub. No.: US 2026/0252892 A1
(43) Pub. Date: Aug. 27, 2026

(54) TECHNIQUE FOR SENSOR-AGNOSTIC TASK HEAD TRAINING

(71) Applicant: Robert Bosch GmbH, Stuttgart (DE)

(72) Inventors: Volker Fischer, Renningen (DE); Xiahan Shi, Renningen (DE)

(21) Appl. No.: 19/463,651

(22) Filed: Jan. 29, 2026

(30) Foreign Application Priority Data
Jan. 31, 2025 (DE) 10 2025 103 624.1

(51) Int. Cl. G06N 3/088

(52) U.S. Cl. CPC G06N 3/088

(57) ABSTRACT

A method for pre-training a task head for a perception task. The method includes: receiving, at an input layer of a task head, a plurality of latent representations, each associated with a first training dataset included in a first training database. Each first training dataset includes optical sensor data acquired by at least one optical sensor, and a perception task label. By hidden layers of the task head, each latent representation is transformed into a perception task result. At an output layer of the task head, the perception task result is output. The weights the task head are pre-trained by optimizing a task-specific loss function, which includes comparing the output perception task result with the perception task label for each of the plurality of received latent representations.

### CROSS REFERENCE

The present application claims the benefit under 35 U.S.C. § 119 of Germany Patent Application No. DE 10 2025 103 624.1 filed on Jan. 31, 2025, which is expressly incorporated herein by reference in its entirety.

### FIELD

The present disclosure relates to a technique for pre-training a task head for a perception task and for performing a perception task, in particular comprising methods, a task head, a neural network system comprising the task head, and a computer program product.

### BACKGROUND INFORMATION

Providing computer-implemented models for performing perception tasks often faces the problems of limited available training data with associated ground truth as well as replacements of sensors. For example, in the automotive and robotic sector, new models of vehicles or robots are often equipped with new versions of optical sensors, on which the model was not trained.

There exist conventional approaches of joint embedding learning with unsupervised, self-supervised and/or domain-adversarial losses, as presented in [1], of style transfer to map target domain data to source domain, as presented in [2], and of label-preserving or label-conditional data synthesis of target domain data, as presented in [3].

However, all these conventional approaches are of limited use, and often require extensive computing resources and training time.

It is an object of the present disclosure to provide a solution for transfer models trained on labeled source domain data for certain tasks to unlabeled target domain data. Alternatively or in addition, an objective is to provide an at least partially sensor-agnostic training, and/or a training technique that reduce a need for computing resources and/or reduces a time for re-training, such as after an exchange of sensors for newer models.

### SUMMARY

This object may be solved by a method for pre-training a task head for a perception task, by a method for performing a perception task, by a task head, by a neural network system, by a computer program (and/or computer program product), and/or by a computer-readable storage medium according to example embodiments of the present disclosure. Advantageous aspects, features, and embodiments are described herein together with certain advantages.

In the following, the solution according to the present disclosure is described with respect to methods as well as with respect to a task head, and s neural network system. Features, advantages or alternative embodiments herein can be assigned to the other aspects of the present disclosure (e.g., a computer program or a computer program product) and vice versa. In other words, the task head and the neural network system can be improved with features described in the context of the methods. In this case, the functional features of the method are embodied by structural units of the system and vice versa, respectively.

As to a first method aspect of the present disclosure, a (in particular computer-implemented) method for pre-training a task head for a perception task is provided.

According to an example embodiment, the method comprises a step of receiving, at an input layer of a task head, a plurality of latent representations. Each latent representation is associated with a first training dataset comprised in a first training database. Each first training dataset comprises optical sensor data acquired by at least one optical sensor. Each first training dataset further comprises a perception task label. The method further comprises a step of transforming, by one or more hidden layers of the task head, each of the plurality of received latent representations into a perception task result. The method further comprises a step of outputting, at an output layer of the task head, the perception task result for each of the plurality of received latent representations. The method further comprises a step of pre-training the weights (e.g., of at least the one or more hidden layers) of the task head by optimizing a task-specific loss function. Optimizing the task-specific loss function comprises comparing the output perception task result with the perception task label for each of the plurality of received latent representations.

By the pre-training technique, the task head is trained (also: pre-trained) on a latent representation (also: world representation, and/or scene representation) of the optical sensor data (and potentially further sensor data, such as motion sensor data), with the latent representation being sensor-agnostic. Thereby, the pre-trained task head can be combined with various encoders (also: converters), which can output such a latent representation. The encoders can, e.g., differ in the type of optical sensor data they are trained for and/or in the at least one optical sensor, by which the optical sensor data are acquired. For example, when an optical sensor (e.g., an older camera) is replaced by an update (e.g., a newer camera), the pre-trained task head can be combined with an updated encoder. Alternatively or in addition, sensor parameters (such as resolution) may differ between optical sensors. The encoders may differ in the sensor parameters (also: sensor-specific parameters) they are pre-trained for.

By only needing to pre-train a second encoder (or re-train a first encoder, which was used to pre-train the task head) if the type of optical sensor data, and/or the optical sensor they are acquired with, changes, it is possible to pre-train the task head for a perception task on a limited amount of first training datasets (also: source domain datasets), which each comprise a label (also: perception task label and/or ground truth) in relation to the perception task, and then transfer the pre-trained task head to a neural network system, which can perform the perception task on further datasets (also: target domain datasets) differing in the at least one optical sensor (and/or sensor parameters), by which the optical sensor data are acquired. The neural network system for performing the perception task may comprise the second encoder, which is trained on second training datasets (also: target domain datasets) without labels. In particular, the task head need not be re-trained, which reduces an amount of time and computing resources required for re-training upon changes in the optical sensor data acquisition.

The modalities (also: types) of optical sensors used for acquiring the first training database of labeled first training datasets and for acquiring a second training database of unlabeled second training datasets may be identical. E.g., at least one camera and at least one LiDAR sensor may be used for acquiring training datasets within the first training database and within the second training database.

According to an example embodiment, the at least one sensor may comprise at least one sensor of a predetermined type (also: modality, measuring principle and/or acquisition principle; e.g., camera or LiDAR).

The at least one sensor may comprise at least two sensors of two different predetermined types.

By the stepwise pre-training of the (in particular sensor-agnostic) task head and the (e.g., second) sensor-specific encoder, which outputs a sensor-agnostic and/or task-agnostic representation, a model complexity can be reduced and/or a size of the sensor-specific encoder can be reduced. Alternatively or in addition, less training data are needed. Less needed training data may apply to needing less labeled training data (also denoted as first training datasets) for training the task head. Alternatively or in addition, needing less training data may apply to less unlabeled training data (also denoted as second training datasets) for training the second encoder.

Applications of the perception task can include autonomous driving and robotics (e.g., for manufacturing and/or for home automation), such as for perception and/or sensor fusion, and/or for controlling actuators.

Autonomous driving may comprise any one of the Level 1 (driver assistance), Level 2 (partial automation), Level 3 (conditional automation), Level 4 (high automation), and/or Level 5 (full automation) according to the Society of Automotive Engineers classification system.

The at least one optical sensor may be configured to capture a scene and/or an environment of a (e.g., autonomously driving) vehicle (also: ego vehicle) and/or of a robot (e.g., at a manufacturing site, and/or in a household). Alternatively or in addition, the at least one optical sensor may be installed at the ego vehicle and/or at the robot.

The at least one optical sensor may be comprised in a first set of sensors. The first set of sensors may comprise sensors of one or more predefined sensor types (also: modalities, acquisition principles, and/or measurement types), such as cameras and LIDAR sensors.

The at least one optical sensor may comprise multiple optical sensors, and/or sensors of different types. Thereby, the latent representation associated with the optical sensor data (also: sensor signal) may be truly sensor-agnostic.

The latent representation may be task-agnostic in the sense that it can be used for pre-training a plurality of task heads for different perception tasks (also: downstream tasks). For example, a first task head may be pre-trained for object detection, such as detecting traffic signs, in the vicinity of an ego vehicle. A second task head may be pre-trained for map estimation, such as estimating shapes of road lanes, in the vicinity of the ego vehicle.

The latent representation may be task-agnostic and/or sensor-agnostic.

Sensor-agnostic (also: the opposite of sensor-specific, and/or not sensor-specific) may correspond to the latent representation not being in a sensor coordinate-frame.

The latent representation may have an internal structure, such as a single Birds-eye-view (BEV) representation around the ego vehicle. Components of the latent representation may represent scene dynamics (e.g., a scene flow and/or object flow) and/or a scene appearance.

The latent representation may be modular, e.g., static vs. temporal, and/or dense vs. sparse. Thereby, a transparency and/or explainability of the pre-training of the task head may be improved. Alternatively or in addition, several auxiliary SSL tasks (SSL: Self-Supervised Learning) may be performed in parallel, improving on the overall pre-training of the task head.

The latent representation may comprise the current scene, and optionally a generative model.

Alternatively or in addition, the first encoder, and/or any further encoder may comprise (and/or may be supplied with) a generative model. Further alternatively or in addition, the task head, and/or a renderer, may comprise (and/or may be supplied with) a generative model.

The generative model may encode a temporal evolution of the optical sensor data. Alternatively or in addition, the generative model may generate sensor inputs for a given sensor parameterization, e.g., to allow for a time evolution.

The (e.g., first and/or second) encoder may be trained, in particular both in the source and target domain, by means of a reconstruction loss the generative model, and optionally auxiliary SSL losses.

The encoder architecture may in principle depend on the sensor modality (also: sensor type, or type of sensor). For example, certain Convolutional Networks (e.g., ResNet, VovNet, etc.) or vision transformer Networks (ViT) may be chosen and/or beneficial for camera inputs. For Radar, inputs other encoder models (e.g., PillarNet) may be better suitable.

The generative model G may depend on a sensor parameterization p. The fact that G may take p as a separate input G(z, p) may makes G independent from the choice of p. G(z, p) with dependence on a latent state z (and/or generic scene representation; also: latent representation) may be mapped using different sensor parameterizations p_1, p_2, e.g., to two different camera views of the same scene: x_1=G(z, p_1), x2=G(z, p_2). In this sense, the scene representation z itself as well as the generative model may be sensor agnostic.

The generative model G need not be part of the (e.g., first and/or second) encoder. Alternatively or in addition, the generative model G may operate on the output z of the (e.g., first and/or second) encoder and generate a sensor state x=G(z, p) given a sensor parameterization.

The (e.g., dense and/or sparse) latent representation may be the output of the (e.g., first and/or second) encoder and the input to both the renderer (and/or generative model) as well as the task heads.

The first training database may comprise first training datasets, which use combinations of one or more optical sensors. For example, the cityscapes database (available at: www.cityscapes-dataset.com/) may provide first training datasets, which are camera-based (and/or acquired by means of one or more cameras as optical sensors). The first training database may alternatively or in addition comprise first training datasets provided by nuScenes (available at: www.nuscenes.org/nuscenes). The datasets in the nuScenes database are acquired by means of up to six cameras, one LiDAR sensor and/or five radar sensors as optical sensors. The datasets in the nuScenes database further include sensor data from motion sensors and/or navigation sensors, such as an inertial measurement unit (IMU) and/or a global positioning satellite (GPS) sensor.

The result of the pre-training of the task head may comprise, or may be, the weights of the task head.

In some example embodiments, the first training datasets may comprise 3D object bounding-box labels for predetermined classes, and optionally other labels for other classes. Thereby, the sensor-agnosticity and/or the task-agnosticity of the pre-training of the task head may be improved.

According to an example embodiment, the method may comprise a step of receiving, at the loss function of the task head, the perception task label associated with each of the plurality of received latent representations.

The perception task label may be received along with the optical sensor data of the first training dataset.

The at least one optical sensor may comprise a camera, a LiDAR sensor, a radar sensor, an ultrasound sensor, and/or a thermal sensor.

Any one of the optical sensors may acquire digital sensor data, and/or may output the optical sensor data in digital form.

The camera may be a fish eye camera or a stereo camera. Alternatively or in addition, the camera may be a video camera.

The at least one optical sensor, such as the video camera, may be suitable for acquiring sensor data for performing a regression and/or determining one or more continuous values, such as distance (e.g., from the ego vehicle or a landmark in the scene, such as a crossing), a velocity, and/or tracking of an item (e.g., an object). The regression and/or the determining of the one or more continuous values may be carried out based on low-level features.

The first training database may comprise first training datasets, which comprise optical sensor data from two or more different optical sensors, and/or from two or more different optical sensor types. Thereby, the task head may be pre-trained for performing the perception task for any combination of optical sensor types used for acquiring the optical sensor data within the first training database.

At least a subset of the first training datasets may further comprise motion sensor data, position sensor data and/or navigation sensor data.

The perception task may be performed based on a combination of optical sensor data and motion-related (e.g., comprising motion, position, and/or navigation) sensor data. Thereby, a motion of the ego vehicle, or of the robot, may be combined with the scene and/or environment captured by the optical sensors.

A temporal evolution of the optical sensor data may be encoded and/or predicted by using the motion-related sensor data of the same scene and/or of the same environment.

The motion sensor data may be acquired by means of a motion sensor. Alternatively or in addition, the position sensor data and/or the navigation sensor data may be acquired by means of a satellite-based navigation system.

By combining multiple sensor types, such as motion sensors and optical sensors, an accuracy of representing the scene and/or of representing the environment by sensor data may be improved.

The plurality of latent representations may be obtained by means of a pre-trained first encoder.

The first encoder may be pre-trained using the first training database by combining the first encoder with a renderer (also: decoder) and optimizing a reconstruction loss.

The renderer may be a white-box renderer or a grey-box renderer. Alternatively or in addition, the renderer may be trained to reconstruct optical sensor data from a latent representation.

A white box (also: glass box, clear box, and/or open box) renderer may be a renderer, which is not trainable, and/or the weights of the white box renderer may not be alterable.

A black box renderer may be (e.g., fully) trainable, and/or (e.g., all) the weights of the black box renderer may be alterable. The training of the black box renderer may depend on the type of sensor and/or on sensor parameters.

A grey-box renderer may be an intermediary between a white-box renderer and a black-box renderer. E.g., the renderer may be trainable depending on a subset of sensor parameters, such as a position of the sensor and/or a range (e.g., a view angle of FOV).

For example, the renderer may be a Gaussian splatting renderer. A Gaussian splatting renderer is a renderer for creating 3D scenes from multiple 2D images by using Gaussian splatting. It represents a scene using Gaussian splats-small, soft blobs that capture identifying parameters, comprising color, position, and/or opacity, which are blended together.

According to an example embodiment, the method may comprise a step of receiving, at an input layer of the first encoder, the optical sensor data comprised in at least a subset of each of the first training datasets. The method may further comprise a step of encoding, by one or more hidden layers of the first encoder, the optical sensor data of each of the received first training datasets within the subset into a latent representation. The method may further comprise a step of outputting, at an output layer of the first encoder, the latent representation.

The method may comprise a step of receiving, at an input layer of a renderer, the output latent representation. The method may further comprise a step of reconstructing, by one or more hidden layers of the renderer, the optical sensor data based on the received latent representation.

The method may comprise pre-training the weights (e.g., of at least the one or more hidden layers) of the first encoder by optimizing a reconstruction loss. Optimizing the reconstruction loss may comprise comparing the reconstructed optical sensor data with the received sensor data.

By pre-training the first encoder separately from the task head, namely by using a renderer and the optimization of the reconstruction loss, the pre-training of the first encoder may be performed in a time-efficient and resource-efficient way.

The first encoder may optionally be finetuned while performing the pre-training of the task head.

The first encoder may be pre-trained for the specific types of optical sensors and/or sensor parameters associated with the optical sensor data comprised in the first training datasets.

Sensor parameters for a camera may comprise extrinsic camera parameters (briefly: extrinsic parameters) and/or intrinsic camera parameters (briefly: intrinsic parameters). The extrinsic parameters may represent the location of the camera in a 3D scene. Alternatively or in addition, the intrinsic parameters may represent an optical center and/or focal length of the camera. World points may be transformed to camera coordinates using the extrinsic parameters.

Sensor calibration may refer to the process of measuring the correspondence between the output of the sensor and the data actually measured by the sensor.

Sensor parameters for a LiDAR sensor may comprise a laser wavelength, detection range, Field of View (FOV), angular resolution, point rate, and/or a number of beams. Alternatively or in addition, the sensor parameters for a LiDAR sensor may comprise a ranging accuracy, safety level, output parameters, IP rating, power, supply voltage, laser emission mode (e.g., mechanical/solid-state), and/or lifespan.

Sensor parameters for a radar sensor may comprise frequency band and/or modulation.

Sensor parameters for an ultrasound sensor may comprise frequency range, detecting area, and/or response speed.

Sensor parameters for a thermal sensor may comprise resolution, pixel pitch, fill factor, magnification, FoV, and/or frame rate.

In some example embodiments, the renderer may not be trained (and/or may not be trainable). In other embodiments, the renderer may be trained in view of at least a subset of sensor parameters.

The renderer may employ a differentiable rendering technique. Alternatively or in addition, the renderer may apply Gaussian splatting. Gaussian splatting may comprise using a position of an optical sensor and/or a view angle of an optical sensor as sensor parameters. Gaussian splatting may further comprise making use of a Gaussian representation.

The renderer may alternatively or in addition make use of surface primitives (and/or line primitives), such as polygonal mesh, and/or of isosurfaces for the rendering.

Scene rendering may comprise a predetermined number of parameters, such as for location, orientation, color (such as RGB), transparency (and/or opacity), scale, and/or spherical harmonics. E.g., a predetermined number of 14 parameters may arise as three parameters for location, four parameters for orientation (e.g., for a quaternion), three parameters for scaling, three parameters for RGB and one parameter for opacity.

The rendering may comprise a texture and/or lighting.

Any encoder, such as the first and/or second encoder, may be a split encoder. A split encoder may comprise a sensor-specific encoder component (also: sensor backbone) and a sensor-agnostic encoder component. The sensor-specific encoder component may, e.g., be convolution-based (e.g., Residual Networks, ConvNet, and/or VovNet), and/or transformer-based (e.g., ViT, and/or SwinTransformers) for a camera as the at least one optical sensor. For a radar sensor as the at least one optical sensor, the sensor-specific encoder component may, e.g., be a Pillar Network.

The split encoder may have the advantage of reducing the number of the second training datasets needed for the pre-training as the second encoder. The sensor-agnostic part (and/or its parameters) may be identical for the first encoder and the second encoder and may only need to be pre-trained once on the first training datasets.

A first component of a split encoder may be Flash3d (e.g., as described in arxiv.org/abs/2406.04343, which is incorporated herein by reference). Flash3d maps an image to a Gaussian representation in the camera frame (e.g., the locations of Gaussians are in the camera frame). In a second step would, either given or estimated (e.g., trained) camera parameters may be used to transform those Gaussians from the camera into an agent and/or ego (e.g., ego vehicle) coordinate frame. The output of this second step can be considered as latent representation (also: latent scene state) z.

Pre-training the task head, and/or pre-training the first encoder, may be accompanied by one or more auxiliary self-supervised learning (SSL) tasks.

By performing several pre-training and/or SSL tasks simultaneously on the first training datasets, and/or using the first encoder, the pre-training may be improved. For example, optimizing the corresponding (e.g., SSL and/or perception) task-specific loss and/or the reconstruction loss may be accelerated.

The one or more auxiliary SSL tasks may be performed without task-specific labels and/or based on optimizing a self-consistency loss.

Optionally, sensor parameters (such as camera parameters) may be used as input for an SSL task of predicting a mask, predicting partial impainting, predicting a geometric transformation, and/or making a temporal prediction of a next frame (e.g., for a video sequence as optical sensor data).

There are various ways to incorporate a temporal evolution in the pre-training of the perception task. In one embodiment, the latent representation may be temporally, and/or spatially, extended by using at least one previous latent representation in addition to a present latent representation.

A scene flow and/or a temporal fusion model may be used, e.g., based on a Long Short-Term Memory (LSTM) model and/or on temporal convolutions.

In alternative example embodiments, a generative model may be used.

The latent representation may comprise, or may be supplied along with, a generative model, which encodes a temporal evolution of the optical sensor data.

The generative model G may operate on the output (e.g., the latent representation) z of the encoder and generate a sensor state x=G(z, p) given a sensor parameterization p.

The latent representation (e.g., dense and/or sparse) may be the output of the (e.g., first and/or second) encoder and the input to both the renderer (and/or generative model G) as well as the task heads.

As to a second method aspect of the present disclosure, a (in particular computer-implemented) method for performing a perception task is provided. According to an example embodiment, the method comprises a step of receiving, at an input layer of a (e.g., pre-trained) second encoder, a dataset comprising optical sensor data acquired by at least one optical sensor. The method further comprises a step of encoding, by one or more hidden layers of the second encoder, the received optical sensor data into a latent representation. The method further comprises a step of outputting, by an output layer of the second encoder, the latent representation. The method further comprises a step of receiving the output latent representation at an input layer of a task head, which is pre-trained according to the method of the first method aspect. The method further comprises a step of transforming, by one or more hidden layers of the (in particular pre-trained) task head, the received latent representation into a perception task result. The method still further comprises a step of outputting, by an output layer of the (in particular pre-trained) task head, the perception task result.

The second encoder may be pre-trained to provide latent representations of the same type as the (e.g., pre-trained) first encoder.

The (e.g., pre-trained) second encoder may be independent of the (e.g., pre-trained) first encoder. E.g., a number of nodes and/or hidden layers, and/or the pre-trained weights of the first and second encoder may be different.

In alternative embodiments, the pre-trained second encoder may have the same architecture as the first encoder, but with weights adapted based on unlabeled second training datasets in a second training database.

Pre-training the second encoder may comprise a step of receiving, at the input layer of the second encoder, a plurality of second training datasets comprised in a second training database. Each second training dataset may comprise optical sensor data acquired by at least one optical sensor. Pre-training the second encoder may further comprise a step of encoding, by the one or more hidden layers of the second encoder, the optical sensor data of each of the received second training datasets into a latent representation. Pre-training the second encoder may further comprise a step of outputting, at the output layer of the second encoder, the latent representation. Pre-training the second encoder may further comprise a step of receiving, at an input layer of a renderer, the output latent representation. Pre-training the second encoder may further comprise a step of reconstructing, by one or more hidden layers of the renderer, the optical sensor data based on the received latent representation. Pre-training the second encoder may still further comprise pre-training the weights (e.g., of at least the one of more hidden layers) of the second encoder by optimizing a reconstruction loss. Optimizing the reconstruction loss may comprise comparing the reconstructed optical sensor data with the received sensor data.

The second training datasets may be unlabeled, and/or the second training database may comprise unlabeled training data.

The at least one optical sensor used for acquiring the optical sensor data may comprise sensors of one or more predefined sensor types. The predefined sensor types for the pre-training of the second encoder may be the same predefined sensor types as for the re-training of the task head.

The optical sensors (and optionally further sensors, such as motion-related sensors) used for acquiring the first training datasets and the optical sensors (and optionally further sensors, such as motion-related sensors) used for acquiring the second training datasets may at least partially differ in a number of sensors, in a sensor mounting position (also: mounting setup), in a sensor model (e.g., a further development and/or newer variant), in sensor-specific parameters, and/or in sensor calibrations.

Training any (e.g., the second) encoder may comprise training encoder parameters and/or encoder weights.

In some example embodiments, the renderer may be the same for pre-training the first encoder and for pre-training the second encoder. In other embodiments, the renderers for the pre-training of the first encoder and of the second encoder may be chosen independently.

In an example embodiment, the renderer may be pre-trained jointly with the first encoder and/or with the task head using the first training database, e.g., if the renderer is a grey-box renderer. The pre-training of the renderer may be based on optimizing the reconstruction loss, and/or may take into account the pre-training of the perception task using the perception task labels, and/or may take into account the SSL of auxiliary tasks.

In another example embodiment, which is combinable with the above-described embodiment, the renderer may be pre-trained jointly with the second encoder using the second training database. The pre-training of the renderer may be based on optimizing the reconstruction loss, and/or may take into account the SSL of auxiliary tasks.

In some example embodiments, pre-training the renderer may comprise providing sensor parameters of the at least one sensor as input to the renderer.

In alternative embodiments, the sensor parameters may be learned by the (e.g., first and/or second) encoder, by the renderer, and/or by the optional SSL tasks.

The perception task may comprise an object detection and/or a classification, in particular in an ego vehicle coordinate frame and/or a robot coordinate frame. Alternatively or in addition, the perception task may comprise an occupancy estimation and/or a visibility estimation. Alternatively or in addition, the perception task may comprise a map estimation, an estimation of drivable areas an ego vehicle, a scene segmentation in a non-sensor specific representation, an object tracking, an object velocity estimation, a depth estimation and/or a distance estimation, an out-of-domain instance detection, and/or a temporal prediction.

The object detection and/or classification may comprise detecting and/or classifying traffic signs, road surfaces, pedestrians, vehicles, and/or a (e.g., 2D or 3D) dense occupancy.

The object detection and/or classification may be based on low-level features, e.g., edges or pixel attributes for images as optical sensor data.

The occupancy estimation and/or visibility estimation may be based on a (e.g., 2D or 3D) voxel grid around the ego vehicle.

The map estimation may comprise an estimation of a road lanes area, e.g., in the ego vehicle coordinate frame.

The segmentation may be performed in a birds-eye-view grid representation.

The depth estimation and/or distance estimation may comprise an estimation in a predetermined direction relative to the ego vehicle and/or relative to the robot.

Out-of-domain (OoD) may denote that a predetermined scene and/or situation was not observed during training and (e.g., in some sense) is very different from the available training data (for example, a person in some costume, a strangely shaped car, etc.). OoD instances may also be referred to as corner-cases or long-tail scenarios.

A first central question may be: To which extend is the encoder and/or the latent scene representation (briefly: latent representation) accurately and/or reliably representing those scenes? This can now be checked by comparing the original input x with the reconstructed input G(E(x), p), where E is the encoder.

It can be checked if the encoding z is truthful to the OoD input. This is a strong property of the latent representation z which is not true for most common encoders, such as CNN and/or ViT, which conventionally remove a lot of information during the encoding x->z and, hence, a re-generation of x based on z is not possible.

A general idea of the technique for pre-training the task head for the perception task of for performing the perception task is that this strong latent representation z can be used for OoD detection. For example, by applying an outlier detection network on z.

The perception task may be applied to the planning of autonomous driving, for performing emergency breaking, for planning movements (such as displacements and/or grasping) of robots, and/or generally for controlling a vehicle or robot.

In the inference phase of performing the perception task, auxiliary SSL tasks and/or an auxiliary reconstruction using a renderer may be performed. Thereby, a control mechanism can be introduced for ensuring that the perception task is correctly performed.

The pre-training techniques for the task head, the first and second encoder as well as performing the perception task may be compatible with network pruning, network quantization, and/or parallelization.

Pruning may comprise removing parameters from the neural network system, or from a component thereof (such as the task head, any one of the encoders, and/or the renderer). Alternatively or in addition, pruning may be a method of compression that involves removing weights from a pre-trained (and/or trained) neural network system, or any component thereof.

Quantization may correspond to reducing the precision of the weights, biases, and/or activations such that they consume less memory.

Parallelizing neural network training across processors (e.g., CPUs and/or GPUs) may involve effectively distributing workloads and synchronizing tasks to maximize computational efficiency.

As to a first device aspect of the present disclosure, a task head for performing a perception task is provided. According to an example embodiment, the task head comprises an input layer, which is configured for receiving a plurality of latent representations. Each latent representation is associated with a first training dataset comprised in a first training database. Each first training dataset comprises optical sensor data acquired by at least one optical sensor. Each first training dataset further comprises a perception task label. The task head further comprises one or more hidden layers, which are configured for transforming each of the plurality of received latent representations into a perception task result. The task head further comprises an output layer, which is configured for outputting the perception task result for each of the plurality of received latent representations. The task head may be pre-trained by optimizing a task-specific loss function. Optimizing the task-specific loss function may comprise comparing the output perception task result with a perception task label for each of the plurality of received latent representations. Alternatively or in addition, the task head may pre-trained by means of the method according to the first method aspect.

The task head may be configured to perform any one of the steps, or comprise any one of the features, described in the context of the first method aspect. For example, the task head may comprise the task-specific loss function the pre-training of the task head.

The output layer (and/or the output heads) may be pre-trained on the source domain (and/or using the first training database) specifically with the available labels from the source domain. In a novel target domain (e.g., for a different sensor setup), those pre-trained output layers (and/or task heads) may be re-used and not changed.

In general, the task specific losses could be used to also train the full architecture, e.g., including the encoder. However, this might cause invariances in the encoder which lead to higher reconstruction errors using the generative model. So, in general one would not use the task heads and/or losses to also train the encoder.

As to a second device aspect of the present disclosure, a neural network system for performing a perception task is provided. According to an example embodiment, the neural network system comprises a (e.g., pre-trained) second encoder. The second encoder comprises an input layer, which is configured for receiving a dataset comprising optical sensor data acquired by at least one optical sensor. The second encoder further comprises one or more hidden layers, which are configured for encoding the received optical sensor data into a latent representation. The second encoder further comprises an output layer, which is configured for outputting the latent representation. The neural network system further comprises a task head according to the first device aspect. The input layer of the task head is configured for receiving the latent representation output by the second encoder. The one or more hidden layers of the task head are configured for transforming the received latent representation into a perception task result. The output layer of the task head is configured for outputting the perception task result.

The neural network system may be configured to perform any one of the steps, or comprise any one of the features, described in the context of the second method aspect. For example, the neural network system may further comprise a renderer.

Alternatively or in addition, the neural network system may further comprise the at least one optical sensor.

The task head and/or the neural network system may be implemented in a graphical processing unit, GPU and/or a tensor Processing Unit, TPU, being an AI accelerator application-specific integrated circuit (ASIC).

As to a further aspect of the present disclosure, a computer program product is provided comprising program elements which induce a task head and a first encoder to carry out the steps of the method for pre-training a task head for a perception task according to the first method aspect, when the program elements are loaded into a memory of the task head and the first encoder. Alternatively or in addition, the program elements induce a neural network system to carry out the steps of the method for performing a perception task according to the second method aspect, when the program elements are loaded into a memory of the computing device.

As to a still further aspect, a computer-readable medium is provided on which program elements are stored that can be read and executed by a task head and a first encoder, in order to perform steps of the method for pre-training a task head for a perception task according to the first method aspect, when the program elements are executed by the task head and the first encoder. Alternatively or in addition, the program elements can be read and executed by a neural network system, in order to perform steps of the method for performing a perception task according to the second method aspect, when the program elements are executed by the neural network system.

### BRIEF DESCRIPTION OF THE DRAWINGS

FIG. 1 is an exemplary flow chart of a method for pre-training a task head for a perception task.

FIG. 2 is an exemplary flow chart of a method for performing a perception task.

FIG. 3 shows an exemplary architecture of a task head, which may be pre-trained for performing a perception task using the method of FIG. 1.

FIG. 4 shows an exemplary architecture of a neural network system for performing a perception task, for example according to the method of FIG. 2.

FIG. 5 schematically illustrates a combination of a first encoder, a renderer, and the task head for the pre-training for the pre-training, for example according to the method of FIG. 1.

FIG. 6 schematically illustrates a combination of a second encoder, a renderer, and the pre-trained task head for performing the perception task, for example according to the method of FIG. 2.

FIG. 7 further schematically illustrates the pre-training of the task head, for example according to the method of FIG. 1.

FIG. 8 further schematically illustrates the pre-training of the second encoder, for example according to the method of FIG. 2.

FIG. 9 schematically illustrates an example of an inference phase, which uses the pre-trained task head and the pre-trained second encoder, for example according to the methods of FIGS. 1 and 2.

Reference signs should not be construed as limiting the scope.

### DETAILED DESCRIPTION OF EXAMPLE EMBODIMENTS

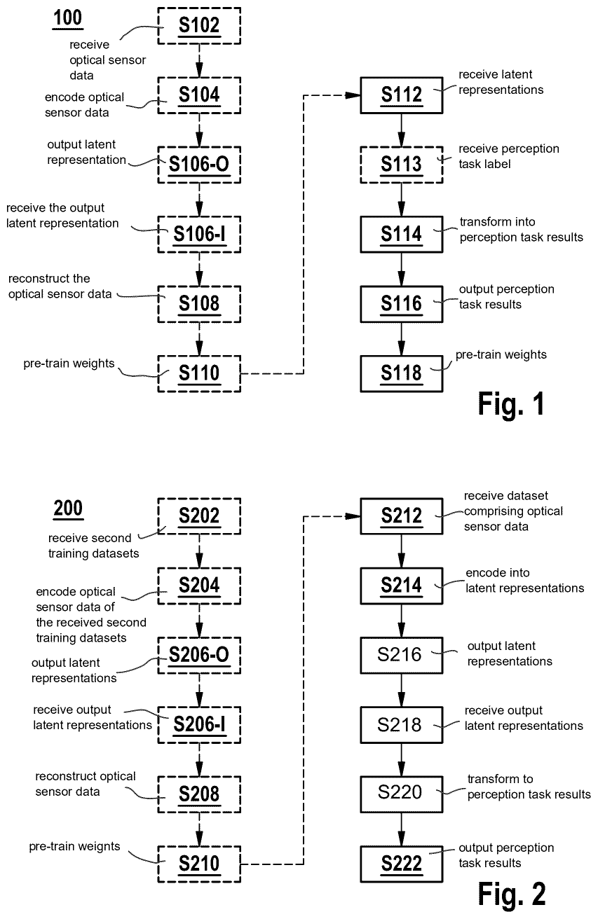

FIG. 1 shows an exemplary flow chart of a (e.g., computer-implemented) method 100 for pre-training a task head for a perception task.

The method 100 comprises a step S112 of receiving a plurality of latent representations at an input layer of a task head. Each latent representation is associated with a first training dataset comprised in a first training database. Each first training dataset comprises optical sensor data acquired by at least one optical sensor as well as a perception task label. The method 100 further comprises a step S114 of transforming each of the plurality of received S112 latent representations into a perception task result. The step S114 is performed by one or more hidden layers of the task head. The method 100 further comprises a step S116 of outputting the perception task result for each of the plurality of received S112 latent representations. The step S116 is performed by an output layer of the task head. The method 100 further comprises a step S118 of pre-training the weights of at least the one or more hidden layers of the task head by optimizing a task-specific loss function. Optimizing the task-specific loss function comprises comparing the output S116 perception task result with the perception task label for each of the plurality of received S112 latent representations.

The method 100 may further comprise a step S113 of receiving the perception task label associated with each of the plurality of received S112 latent representations. The perception task label may be received S113 at the loss function of the task head.

Each latent representation may be received S112 from a pre-trained first encoder.

Pre-training the first encoder may comprise a step S102 of receiving the optical sensor data comprised in at least a subset of each of the first training datasets. The optical sensor data may be received S102 at an input layer of a first encoder. Pre-training the first encoder may further comprise a step S104 of encoding the optical sensor data of each of the received S102 first training datasets within the subset into a latent representation. The encoding may be performed by one or more hidden layers of the first encoder. Pre-training the first encoder may further comprise a step S106-O of outputting the latent representation. The latent representation may be output S106-0 by an output layer of the first encoder. Pre-training the first encoder may further comprise a step S106-1 of receiving the output S106-0 latent representation at an input layer of a renderer. Pre-training the first encoder may further comprise a step S108 of reconstructing the optical sensor data based on the received S106-I latent representation by one or more hidden layers of the renderer. Pre-training the first encoder may further comprise pre-training S110 the weights of at least the one or more hidden layers of the first encoder by optimizing a reconstruction loss. Optimizing the reconstruction loss may comprise comparing the reconstructed S108 optical sensor data with the received S102 sensor data.

FIG. 2 shows an exemplary flow chart of a (e.g., computer-implemented) method 200 for performing a perception task. The method 200 comprises a step S212 of receiving a dataset comprising optical sensor data acquired by at least one optical sensor at an input layer of a (in particular pre-trained) second encoder. The method 200 further comprises a step S214 of encoding the received S212 optical sensor data into a latent representation. The step S214 is performed by one or more hidden layers of the second encoder. The method 200 further comprises a step S216 of outputting the latent representation at an output layer of the second encoder. The method 200 further comprises a step S218 of receiving the output S214 latent representation at an input layer of a pre-trained task head. The task head may be pre-trained according to the method 100. The method 200 further comprises a step S220 of transforming the received S218 latent representation to a perception task result. The step S220 is performed by one or more hidden layers of the pre-trained task head. The method 200 further comprises a step S222 of outputting the perception task result at an output layer of the pre-trained task head.

Pre-training the second encoder may comprise a step S202 of receiving a plurality of second training datasets comprised in a second training database at the input layer of the second encoder. Each second training dataset may comprise optical sensor data acquired by at least one optical sensor. Pre-training the second encoder may further comprise a step S204 of
encoding the optical sensor data of each of the received S202 second training datasets into a latent representation. The encoding S204 into a latent representation may be performed by the one or more hidden layers of the second encoder. Pre-training the second encoder may further comprise a step S206-O of outputting the latent representation at the output layer of the second encoder. Pre-training the second encoder may further comprise a step S206-1 of
receiving the output S206-O latent representation at an input layer of a renderer. Pre-training the second encoder may further comprise a step S208 of reconstructing the optical sensor data based on the received S206-I latent representation. The reconstructing S208 may be performed by one or more hidden layers of the renderer. Pre-training the second encoder may further comprise pre-training S210 the weights of at least the one of more hidden layers of the second encoder by optimizing a reconstruction loss. Optimizing the reconstruction loss may comprise comparing the reconstructed S208 optical sensor data with the received S202 sensor data.

The renderer for pre-training the first encoder for the pre-training of the task head and the renderer for pre-training the second encoder for performing the perception task may be independently selected. In some embodiments, the renderer weights of the renderer may be fixed (e.g., for a white-box renderer), whereas in other embodiments, the renderer may at least be partially trained along with the corresponding encoder.

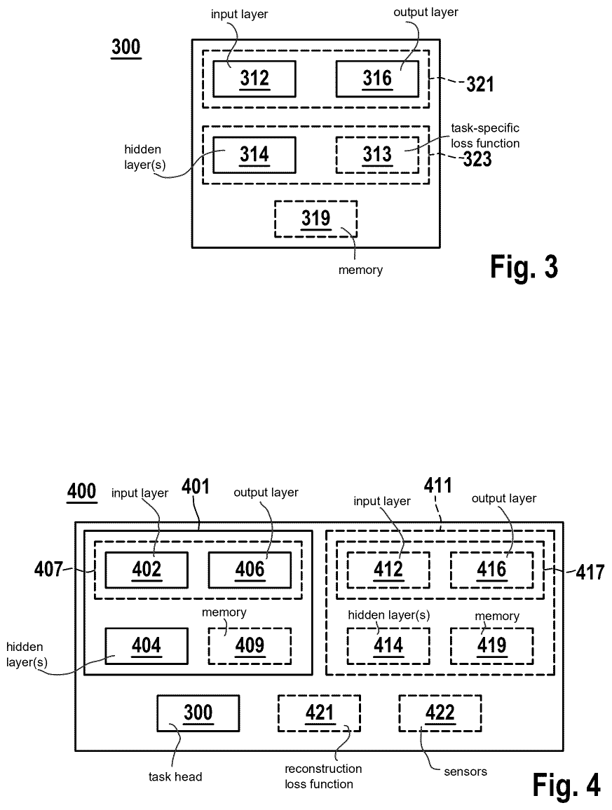

FIG. 3 shows an exemplary architecture of a task head 300 for performing a perception task. The task head may be pre-trained according to the method 100.

The task head 300 comprises an input layer 312, which is configured for receiving a plurality of latent representations. Each latent representation is associated with a first training dataset comprised in a first training database. Each first training dataset comprises optical sensor data acquired by at least one optical sensor as well as a perception task label. The task head 300 further comprises one or more hidden layers 314, which are configured for transforming each of the plurality of received latent representations into a perception task result. The task head 300 further comprises an output layer 316, which is configured for outputting the perception task result for each of the plurality of received latent representations.

The task head 300 may be pre-trained by optimizing a task-specific loss function. Optimizing the task-specific loss function may comprise comparing the output perception task result with a perception task label for each of the plurality of received latent representations. Alternatively or in addition, the task head 300 may be pre-trained by means of the method 100.

The task head 300 may comprise the task-specific loss function 313, at which the perception task label associated with each of the plurality of received latent representations is received.

The task head 300 may comprise a memory 319.

The task head 300 may comprise an input-output interface 321. The input layer 312 and/or the output layer 316 may be embodied by the input-output interface 321.

The task head 300 may comprise a processor 323. The one or more hidden layers 314 and/or the optional task-specific loss function 313 may be embodied by the processor 323.

FIG. 4 shows an exemplary architecture of a neural network system 400 for performing a perception task. The neural network system 400 comprises a second encoder 401. The second encoder 401 may be pre-trained. The second encoder comprises an input layer 402, which is configured for receiving a dataset comprising optical sensor data acquired by at least one optical sensor. The second encoder 401 further comprises one or more hidden layers 404, which are configured for encoding the received optical sensor data into a latent representation. The second encoder 401 further comprises an output layer 406, which is configured for outputting the latent representation.

The second encoder 401 may comprise an input-output interface 407. The input-output interface 407 may embody the input layer 402 and/or the output layer 406.

The second encoder 401 may comprise a processor. The processor may embody the one or mor hidden layers 404.

The second encoder 401 may comprise a memory 409.

The neural network system 400 further comprises a task head 300. The input layer 312 of the task head 300 is configured for receiving the latent representation output by the second encoder 401. The one or more hidden layers 314 of the task head are configured for transforming the received latent representation to a perception task result. The output layer 316 of the task head 300 is configured outputting the perception task result.

The neural network system 400 may be configured for performing several perception tasks. Alternatively or in addition, the neural network system 400 may comprise multiple task heads 300.

The neural network system 400 may further comprise a renderer 411.

The renderer 411 may comprise an input layer 414, which is configured to receive the latent representation output by the second encoder 401.

The renderer 411 may further comprise one or more hidden layers 414, which are configured to reconstruct the optical sensor data based on the received latent representation.

The renderer 411 may further comprise an output layer 416, which is configured for outputting the reconstructed optical sensor data.

The renderer 411 may comprise an input-output interface 417. The input-output interface 417 may embody the input layer 412 and/or the output layer 416.

The renderer 411 may comprise a processor. The processor may embody the one or more hidden layers 414.

The renderer 411 may comprise a memory 419.

The neural network system 400 further comprise a reconstruction loss function 421.

The second encoder 401 (and/or the weights of at least its one of more hidden layers) may be pre-trained by optimizing a reconstruction loss. Optimizing the reconstruction loss may comprise comparing the optical sensor data, which are reconstructed by the renderer 411, with the sensor data received by the second encoder 401.

The neural network system 400 may further comprise a set of sensors 422.

The technique (e.g., comprising the method 100, the method 200, the task head 300, and/or the neural network system 400) may alternatively be denoted as domain transfer with sensor-agnostic world models.

The technique may use a task-agnostic as well as sensor-agnostic latent representation (also known as world-representation) to function as a universal interface between different sensor and down-stream task setups.

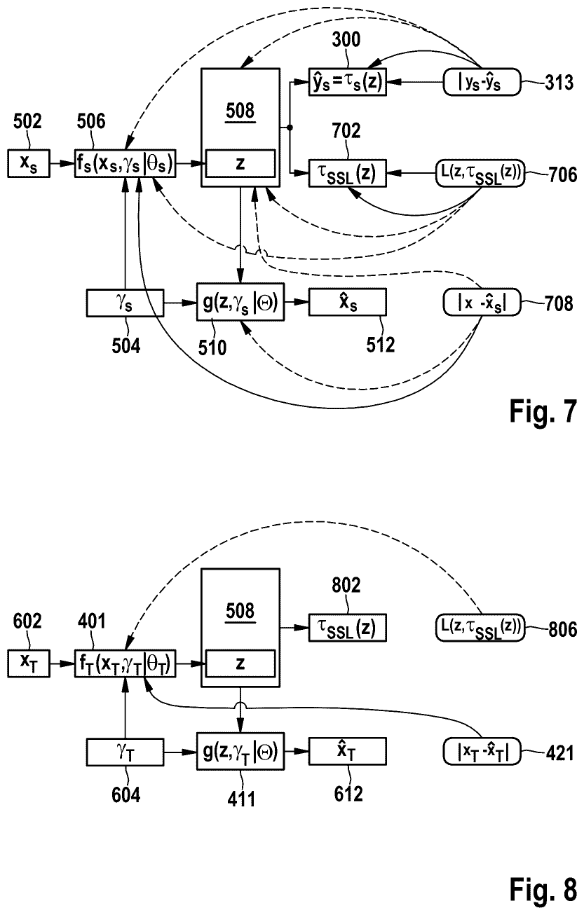

The world-model, as exemplarily shown in FIG. 7, may comprise a (e.g., certain) latent representation z that represents the current scene plus a generative model g( ), that—given some sensor parameterization γₛ (e.g. camera extrinsics and/or camera intrinsics)—can generate according sensor inputs xₛ:

$$\\ {x}_{s} = g ( z , {γ}_{s} ) .$$

Said differently, the generative model g( ) takes the latent z and the sensor parameters γₛ as inputs and reconstructs the sensor input xₛ.

A key idea is, as exemplarily shown in FIG. 8, for a new target domain x_{T} (e.g., for new sensors of the same modality as previous sensors, such as newer cameras of higher resolution than older cameras) to learn a converter and/or encoder f_{T}(x_{T}, γ_{T}|θ_{T})=z into the latent (also: world-model) representation z via the self-supervised loss:

$$\\ {θ}_{T} = arg {min}_{θ} \vert {x}_{T} - g ( {f}_{T} ( {x}_{T} , {γ}_{T} \vert θ ) ) \vert .$$

Here, γ_{T} are (e.g., some) sensor parameters (e.g., camera intrinsics and/or camera extrinsic) in the target domain that are either known from the system setup or can be considered as additional, trainable encoder parameters, |·| is some reconstruction loss in the input sensor domain, and OT are the trainable encoder parameters.

According to the technique (e.g., comprising the method 100, the method 200, the task head 300, and/or the neural network system 400), a rather general approach how to transfer different aspects from potentially multiple source-domains to novel target domains is applied, including for example the transfer of task heads trained on labeled source-domain data to novel target domains without any need for labels in the target domain. Since the technique is rather generic, numerous solutions exist to fill in certain gaps.

The source domain may comprise a set of (e.g., at least one) optical sensor with associated sensor parameters. The first training database may comprise first training datasets, which each comprise optical sensor data acquired by at least one optical sensor within the set. Each first training dataset may further comprise at least one perception task label. In some embodiments, several task heads may be trained for performing different perception tasks, and the first training database may comprise first training datasets that comprise multiple perception task labels for the different perception tasks. A size of the first training database may be limited by the availability of the perception task labels.

The target domain may comprise another set of (e.g., at least one) optical sensor with associated sensor parameters. The sensor modalities (also: types of sensors) in the target domain may be identical to the sensor modalities (and/or types of sensors) in the source domain. The optical sensors (briefly also: the sensors) may differ in values (e.g., resolutions) of the sensor parameters in the source domain and in the target domain.

In the target domain, second training datasets may be acquired, in particular without any perception task labels. A (e.g., extensive) second training database comprising the second training datasets may thus be generated efficiently.

A central advantage of the technique (e.g., comprising the method 100, the method 200, the task head 300, and/or the neural network system 400) is the application of pre-trained task heads τₛ(z)=ŷₛ from a source domain S (and/or sensor setup) onto a novel target domain (and/or modified sensor setup) without any need for labels or pseudo labels in the target domain. Thereby the target domain may vary with respect to the source domain sensor setup in particular in the following manners: a number of sensors, one or more sensor mounting positions, and/or sensor-specific parameters, such as for a camera, e.g. camera intrinsics, camera extrinsic, and/or image resolution.

Alternatively or in addition, a relative sensor calibration in the target domain can be learned in a data-driven manner, e.g., the sensor parameters γ_{T} can also be considered as being part of the trainable encoder parameters θ_{T}.

A key application of the technique (e.g., comprising the method 100, the method 200, the task head 300, and/or the neural network system 400) is to enable strong pre-trained downstream perception tasks (such as object detection, occupancy estimation, segmentation, tracking, etc.) on a new target domain without any labels (and/or by zero-shot learning) from the target domain. This can be applied to re-use strong pre-trained perception task heads in novel sensor setups, e.g., for other manufacturers (and/or customers), who aim at performing perception tasks using optical sensors.

The technique (e.g., comprising the method 100, the method 200, the task head 300, and/or the neural network system 400) can be used for analyzing data obtained from a (in particular optical) sensor. The sensor may determine measurements of the environment in the form of sensor signals, which may be given by, e.g., digital images, e.g. video, radar, LiDAR, ultrasonic, motion, and/or thermal images.

In general, all non-sensor-specific downstream tasks in the context of autonomous driving and robotics can be considered. “Non-sensor-specific” may mean that the (e.g., perception) task outputs are not allowed to be in a sensor coordinate-frame. For example, semantic segmentation would not necessarily fall under technique (e.g., comprising the method 100, the method 200, the task head 300, and/or the neural network system 400), since its output is a pixel-wise classification and, hence, is dependent on the specific camera settings.

Alternatively or in addition, the following downstream (e.g., perception) tasks may fall under the technique (e.g., comprising the method 100, the method 200, the task head 300, and/or the neural network system 400): (e.g., 3D) object detection and/or classification in an ego vehicle coordinate frame; occupancy, and/or visibility estimation (for example, in a 2D or 3D voxel grid around the ego vehicle); map estimation, e.g. estimation of road lanes area in the ego vehicle coordinate frame; estimation of drivable areas relative to the ego vehicle; object tracking; segmentation in a non-sensor specific representation, such as in a birds-eye-view grid representation; object velocity estimation; depth and/or distance estimation in a certain direction relative to the ego-vehicle; and/or out-of-domain instance detection.

Virtual Sensors may be used. Alternatively or in addition, based on the (e.g., optical) sensor signal, an information about elements encoded by the sensor signal may be obtained (e.g., an indirect measurement may be performed based on the sensor signal used as direct measurement).

A video and/or audio analysis (and/or any further analysis of the sensor data) may be performed, such as for classification and/or regression. The technique (e.g., comprising the method 100, the method 200, the task head 300, and/or the neural network system 400) can, e.g., be used for classifying the sensor data, detecting the presence of objects, such as regarding traffic signs, road surfaces, pedestrians, vehicles, and/or 2d (and/or 3d) dense occupancy. The classification may be carried out based on low-level features (e.g., edges or pixel attributes for images). Alternatively or in addition, the technique (e.g., comprising the method 100, the method 200, the task head 300, and/or the neural network system 400) can be used for determining a continuous value or multiple continuous values, and/or for performing a regression analysis, e.g., regarding a distance, a velocity, and/or tracking an item, e.g., an object, in the data. The regression and/or the determination of the continuous values may be carried out based on low-level features (e.g., edges or pixel attributes for images).

The technique (e.g., comprising the method 100, the method 200, the task head 300, and/or the neural network system 400) can be viewed as an upstream part in a machine learning (ML) tool chain. It does not necessarily directly improve a ML system that can be used for the above applications, but is a method to train such an ML system, and/or is a method to train a task head, and/or an encoder (and/or converter) for novel input sensor setups.

After being trained in this way, the ML system can then be put to downstream use.

All the standard techniques regarding network pruning, network quantization or parallelization can be applied to the technique (e.g., comprising the method 100, the method 200, the task head 300, and/or the neural network system 400). The technique (e.g., comprising the method 100, the method 200, the task head 300, and/or the neural network system 400) itself does not specifically need to allow for hardware optimizations beyond that.

The technique (e.g., comprising the method 100, the method 200, the task head 300, and/or the neural network system 400) can be an integral part of an autonomous system's perception and fusion architecture, and/or can be used in various system setups and downstream applications.

The technique (e.g., comprising the method 100, the method 200, the task head 300, and/or the neural network system 400) uses latent representations and/or world models as, e.g., described in [7], [8], [9], [10].

Gaussian splatting and/or scene rendering may be made use of as, e.g., described in [11].

In an embodiment, the setup comprises multiple tasks (such as object detection, temporal prediction, etc.) denoted as τ₁, . . . , τ_{L}. At least one source domain (e.g., optical) sensor with sensor-specific (e.g., camera) parameters yS exists. Source domain data Dₛ={((x_{s,i}, y^{T,L}_{s,i}, . . . , y^{T,L}_{s,i})), i=1, . . . , N} comprise optical sensor data x_{s,i} and prediction task labels y^{T,1}_{s,i} with possibly multiple source domains S₁, . . . , S_{K}. A renderer and/or generative mapping xₛ=g(z, γₛ) from a latent representation z with some sensor parameters γₛ to the respective sensor signal (also: optical sensor data) is provided. A neural network (e.g., first and/or second) encoder z=fₛ(xₛ, γₛ|θₛ) is configured for mapping from the sensor signal xₛ to the latent representation z. Target domain data D_{T}={((x^{T,i})), i=1, . . . , M} are unlabeled.

A goal is to apply and transfer the task heads τ₁, . . . , τ_{L} from the source domains S₁, . . . , Sₖ with source domain data D_{s,i} to the novel and unlabeled target domain data D_{T}.

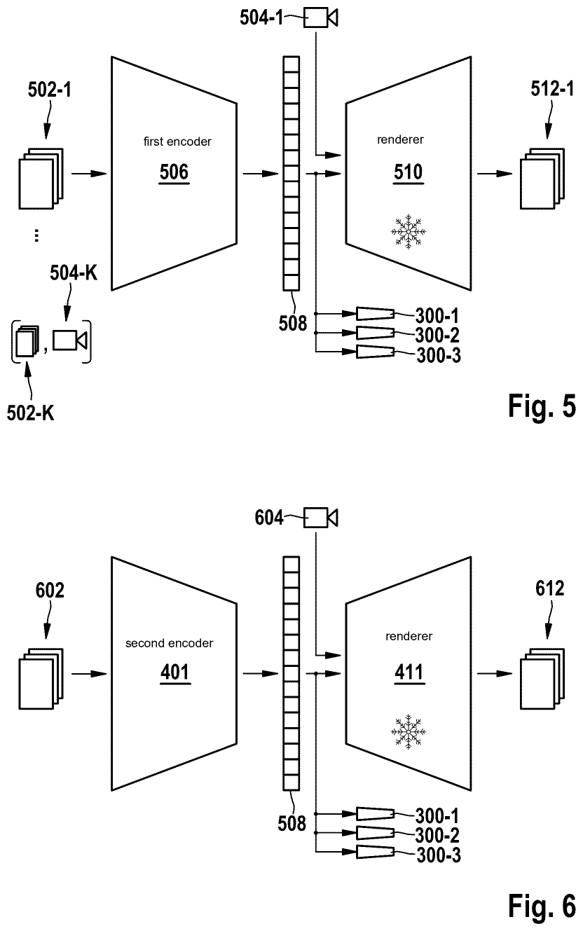

The technique can be grouped (in particular temporarily) into three phases. In a first phase (also: task head pre-training phase), as schematically indicated in FIG. 5, one or more task heads 300 (or 300-1; 300-2; 300-3) are pre-trained (e.g., according to the method 100) on a (e.g., sensor and/or task) agnostic (e.g., world model) latent representation z, which is indicated at reference sign 508 in FIG. 5, obtained from source domain data 502-1, . . . , 502-K received from sources (and/or, in particular optical, sensors) 504-1, . . . , 504-K and encoded by the first encoder 506. A renderer (also: decoder) 510 provides reconstructed data 512-1. As indicated by the snow flake symbol, the renderer 510 may be a white-box renderer. As indicated by the arrow from the optical sensor 504-1 to the renderer 510, sensor-specific parameters may be used for the rendering.

FIG. 7 provides an alternative schematic view on the first phase. In FIG. 7, parallel to the one or more task heads 300, which is trained by a supervised loss (and/or the perception task-specific loss) 313, auxiliary SSL task heads 702 may be trained without using labels and using the self-consistency losses 706, while the reconstruction loss 708 is used to train the first encoder 506. Continuous arrows show the primary use of the losses 313; 706; 708. Dashed arrows show further potential influences of the losses 313; 706; 708 on other components.

The first phase may be similar to a standard multi-task setup. With reference to the embodiment of FIGS. 5 and 7, the first encoder (and/or source-domain encoder fₛ) 506 maps the sensor input xₛ at reference sign 502-1, . . . , 502-K to its latent representation z at reference sign 508: z=fₛ(xₛ, γₛ|θₛ). Multiple task heads τⱼ(z|φⱼ), j=1, . . . , L (briefly also: Ts) at reference sign 300; 300-1, . . . 300-3 map from the latent representation z 508 to the respective task output (and/or perform the respective downstream source task), which is supervised, at reference sign 313, by the respective label y^{τj}. Auxiliary self-supervision (SSL) tasks τⱼ(z, γₛ|φⱼ), j=L+1, . . . , L′ at reference sign 702 map from the latent representation z 508 to the respective output, which is supervised by self-supervision as indicated at reference sign 706. The SSL tasks 702 may, or may not, take sensor-specific (e.g., camera) parameters as input. Examples for SSL tasks comprise masked prediction, partial impainting, geometric transforms, and/or temporal predictive of the next frame. The renderer (also: decoder) xₛ=g(z, γₛ|Θ) at reference sign 510 maps from the sensor-agnostic latent representation z 508 to the reconstruction of a certain sensor input 512; 512-1, supervised by a reconstruction loss 708 between input 502; 502-1 and output 512; 512-1:Θ=argmino′|xₛ−g(f_{T}(xₛ, γₛ|θₛ), γₛ|Θ′)|, and can be trained accordingly. In an alternative embodiment, the decoder 510 may be a white-box renderer without additional and/or trainable parameters, i.e. Θ may be empty.

A differentiating (e.g., from the standard multi-task setup) ingredient of the technique (e.g., comprising the method 100, the method 200, the task head 300, and/or the neural network system 400) may be the special decoder 510 for signal reconstruction, which may be a white-box or grey-box renderer that takes a latent representation 508 and a set of sensor (and/or camera) parameters as inputs and maps to the corresponding sensor signal 512.

A key for the technique (e.g., comprising the method 100, the method 200, the task head 300, and/or the neural network system 400) is that the resulting latent representation 508 may be a so-called “world model”, which is both task-agnostic and domain and/or sensor-agnostic, e.g., both due to the multi-task 300-1; 300-2; 300-2 and additional self-supervision 702 training.

It is noted that, in the context of the technique (e.g., comprising the method 100, the method 200, the task head 300, and/or the neural network system 400), domain and/or sensor-agnostic does not mean (or does not necessarily mean) that the technique is expected to generalize from mere RADAR source domains to completely different physical sensor domains, such as vision (and/or camera sensors). Rather, having camera sensors in the source domain can be used, in the context of the technique (e.g., comprising the method 100, the method 200, the task head 300, and/or the neural network system 400), to generalize, e.g., to different video domains (such as in terms of numbers of sensors, sensor mounting positions, and/or sensor-specific parameter). Alternatively or in addition, in case the source domain comprises a mixture of different modalities (e.g., RADAR and Vision/Camera and Lidar), for example by combining different datasets, the latent representation (and/or the world model) and, hence, the task heads may be transferable from this source domain to, for example, novel mounting setups of those sensors or different camera models.

An exemplary embodiment for a white-box renderer 510 in the vision domain is Gaussian Splatting (GS), which takes camera position and/or view angle as sensor parameters together with a Gaussian representation to render the camera images. The GS renderer does not need any training. It is noted that, in case of a mere white-box renderer, only the downstream task heads will be trained in a supervised manner on the white-box world representation during the first phase.

In a second phase (also: target-domain encoder, and/or second encoder, pre-training phase), a transfer to the target domain is performed.

With reference to the example in FIGS. 6 and 8, for a novel target domain 604, the goal is to train a target-domain specific encoder (also: second encoder) f_{T}(x_{T}, γ_{T}|θ_{T})=z, as indicated at reference sign 401, that maps the target domain data 602 into the latent (also: world-model) representation z 508. The two primary losses to train the target-domain specific encoder (and/or second encoder) 401 are the self-supervision losses 806 of further SSL tasks 802 (which may be independently chose from the SSL tasks 702 of the first phase), which can be applied for the unlabeled target domain training, and the reconstruction loss 421 given by the decoder (and/or renderer) 411 that is used to train the second encoder 401: θ_{T}=argmine|x_{T}−g(f_{T}(x_{T}, γ_{T}|θ), γ_{T})|.

A key in the second phase may be that the renderer xₛ=g(z, γₛ|θ) at reference sign 411 may be fixed, i.e. the decoder parameters Θ may not be trained, which means that the meaning of the latent representation 508 stays the same across domains. Therefore, the task heads 300; 300-1; 300-2; 300-3 from the source domains are expected to generalize without further training.

The renderer 411 may be valid without modification and may be able to reconstruct the target domain sensor signal 602 from the latent representation (also: latent code) 508, and obtain the reconstructed sensor signal 612, by taking the target domain sensor parameters 604 as additional input.

The trainable part in the second phase may be the (e.g., domain-specific and/or) second encoder 401 that can correctly map the target domain to the agnostic latent (also: world model) representation 508.

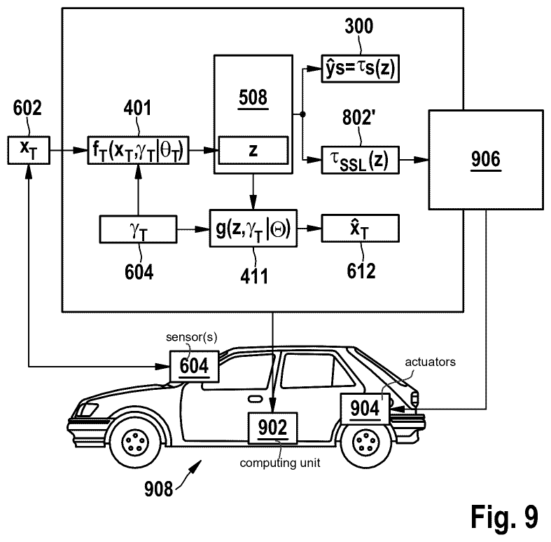

In a third phase (also: inference phase and/or inference target domain) as exemplarily shown in FIG. 9, and/or at inference time (in particular on the target domain), the model (and/or neural network system 400) comprises the target domain encoder (also: second encoder) z=f_{T}(x_{T}, γ_{T}|θ_{T}) at reference sign 401 mapping target domain inputs 602 to the agnostic latent (also: world model) representation 508. The model (and/or neural network system 400) further comprises one or more task heads τⱼ(z)|φⱼ), j=1, . . . , L mapping from the latent representation 508 to the respective task output.

A given input x_{T}, at reference sign 602, in the target domain is, in the inference phase, first mapped to the latent (also: world) representation z, at reference sign 508, using the trained target-domain (also: second) encoder 401, and then the downstream task heads 300 can be applied onto this z.

In FIG. 9, exemplarily auxiliary SSL task heads 802′ are shown. The SSL task heads 802′ in the inference phase may be the same as the SSL task heads 802 in the phase of training the second encoder 401.

In FIG. 9, an exemplary application 902 to the planning of autonomous driving is shown, with the autonomously driving vehicle 908 comprising one or more sensors 604, the neural network system 400 incorporated in a computing unit 902 of the vehicle 908, and the downstream tasks configured for controlling actuators 904. Further exemplary applications 902 comprise emergency breaking, distance estimate, out-of-domain activities, and/or planning and/or grasping for robotics.

If is noted that the reference sign 504; 604 is used for both, the sensor and its sensor-specific parameters for ease of notation.

In an embodiment, in case the sensor parameters γ_{T} that define the target-domain sensors are unknown, they can be learned in addition to the pre-training of the target-domain (also: second) encoder in second phase. These trainable parameters should be consistently used for the target-domain (also: second) encoder, the decoder (also: renderer), as well as potential SSL tasks that depend on sensor parameters.

In a further embodiment, the technique may be temporally extended. In most reals world application of autonomous agents (and/or autonomous driving), the input is available in a streaming and/or temporal manner where succeedingly new sensor inputs enter the system x^{t}_{T}, xt^{+Δt}^{_{T}}, and the world-representation zₜ needs to be updated accordingly in a temporal manner. To capture this temporal aspect, the (e.g., first and/or second) encoders for source and/or specifically target domain can be extended to take the previous world-representation into account: z^{t+Δt}^{_{T}}=f_{T}(x^{t+Δt}^{_{T}}, zₜ, γ_{T}|θ_{T}). In this embodiment, it is also beneficial to extend the latent representation (also: world-representation) with a dynamic representation, such as a scene flow.

It is noted that a mix between source and target domains is possible. For example, for some downstream task, only static (and/or non temporal) datasets might be available. Hence, during the first phase of pre-training the task head, only static (e.g., first) encoders may be used in the source domain. Alternatively or in addition, in the target domain also temporal (e.g., second) encoders may be used.

Simple versions of such temporal fusion models include, but are not limited to, LSTM models and/or temporal convolutions.

In a still further embodiment, a world model predictor is applied. In the context of a temporal encoder it is beneficial to structure the temporal encoder into a world-model predictor \hat{z}_{t+Δt}=p(zₜ, Δt|θₚ) that predicts the previous latent representation (also: world state) by some continuous (and/or consecutive) time interval Δt into the future: z_{t+Δt}=f_{T}(x^{t+Δt}^{_{T}}, p(zₜ, Δt|θₚ), γ_{T}|θ_{T}).

It is noted that this world model predictor is sensor agnostic, and/or independent on the sensor domain T (and/or S). Hence, the predictor p may only be trained during the first phase of pre-training the task heads on the source domains (which in this case need to include temporal data, e.g., video data) and, crucially, p may be fixed during the second phase of pre-training the second encoder and/or may not be trained on target domains.

Dependent on the nature of the world representation z, different architectures for the predictor p may be beneficial, e.g., in case of dense components of z, dense architectures like convolutions may be beneficial. In case of sparse and/or token-based components of z, transformer-based architectures may be beneficial to use.

In another embodiment, domain specific backbones may be applied. Since the world representation (also: latent representation) might be very abstract, it may be necessary to employ rather large architectures and/or models for the encoders f_{T} with a large number of trainable parameters. To alleviate this and to further reduce the number of needed data in the target domain to train the target-domain encoder, one can in general separate the encoders into a sensor-specific encoder (also commonly referred to as sensor backbone) and a sensor-agnostic encoder component f:z=f(f_{T}(x_{T}|θ_{T}), γ_{T}|θ_{f}). Here, θ_{f} are the trainable parameters of the sensor-agnostic world-model. The sensor-agnostic model component f(·|θ_{f}) only needs to be trained during the first phase of pre-training the task heads on the source domains, and/or may be kept fixed during the second phase of the training on the target domain. In this way, f is kept sensor agnostic.

In the context of the technique of the present disclosure, the term “world-model” may be used to indicate that the latent representation is sensor, domain, and/or task agnostic. I.e., it may model and/or represent the world (also: scene) to large extent independently from the used sensor setup and/or desired output tasks. So “world model” may be rather a descriptive attribute of the described latent representation and need not be a concept on its own, e.g., there need not be any function etc. that is the “world model”. In this sense, the world model need also not be part of something else. It may be true that the encoder and renderer can be considered (at least to some extent) each other's inverse, but this need not be directly related to the term “world model”. It may be (e.g., rather) through the flexibility of the encoder and renderer to be used on different sensor setups that the latent representation z becomes a world model.

Parts of the otherwise sensor-dependent encoder may also be formulated in a sensor-agnostic manner which to some extent makes it (or them) part of the “world model” that the representation z is (or represents).

The sensor-dependent encoders f_{S/T}(·|θ_{S/T}) may be trained, respectively, either on the source domains S or the target domains T.

Different domain-specific backbones can be beneficial dependent on the physical nature of the sensor. For example, convolution based architectures (e.g., Residual Networks, ConvNext, VovNet, etc.) or transformer-based architectures (e.g., VIT, SwinTransformers) can be beneficial for camera inputs, while, e.g., for RADAR PillarNetwork or other simpler architectures may be beneficial.

According to further embodiments, different variants for world-representations may be used.

A modular world-representation may be beneficial, e.g., if the world and/or scene representation z has some internal structure of varying complexity. This can range from a single BEV (Birds-eye-view) representation of the scene around the ego vehicle to several components representing different aspects of the scene, such as scene dynamics (e.g., scene flow, object flow, etc.), and/or scene appearances.

A more modular (e.g., static vs. temporal, and/or dense vs. sparse) world-representation, e.g., z=(z_{static}, zdynamic), (in particular compared to an unstructured “block-box” representation) may be most beneficial since it allows for more SSL losses, is more transparent and explainable. Alternatively or in addition, a more structured and/or modular latent representation z can be beneficial, for example considering z=(z_{static}, z_{dynamic}) where z is modularized into a part that represents the static scene features (e.g., where are objects, what is their appearance, etc.) and a part that represents the static scene features (e.g., in which direction and/or at which speed are objects moving).

According to another embodiment, multiple, complementary source-task-domains for task head pre-trainings may be used in the first phase, e.g., one source domain may comprise 3D object bounding-box labels for certain classes, and another source-domain may comprise labels for other and/or additional classes. This can be beneficial in two central aspects. This embodiment may be more sensor-agnostic. The more and/or diverse sensors are available during the first phase of pre-training the task heads, the more versatile the world-representation and the decoder become, and the potential target-domains are enabled by the diverse source-domain setup. Alternatively or in addition, this embodiment may be more task-agnostic. The downstream tasks from all used source domains (e.g., datasets) may become available as downstream tasks also in the target domain, enhancing and extending the system capabilities on the target domain.

All embodiments presented herein are combinable with each other, unless otherwise specified. Combining several, or all, of the above embodiments may be particularly (or most) beneficial.

E.g., specifically, combining the world model predictor and the domain specific backbones can move model complexity from the sensor-specific encoders into the sensor-agnostic world-model components. Such combinations may be beneficial in order to reduce the complexity and/or size of the sensor encoders f_{S/T}(·|θ_{S/T}) and, hence, specifically in the target domain less data may be needed to train the target domain encoder (and/or the second encoder).

The technique (e.g., comprising the method 100, the method 200, the task head 300, and/or the neural network system 400) specifically targets the transfer from source domains to target domains. The technique may, e.g., be used in the context of autonomous driving.

### REFERENCES MENTIONED HEREIN

[1] “Domain generalization: A survey” (arxiv.org/abs/2103.02503)
[2] “Real-Time Monocular Depth Estimation Using Synthetic Data With Domain Adaptation via Image Style Transfer” (openaccess.thecvf.com/content_cvpr_2018/html/Atapour-Abarghouei_Real-Time_Monocular_Depth_CVPR_2018_paper.html)
[3] “Locality Preserving Joint Transfer for Domain Adaptation” (ieeexplore.ieee.org/abstract/document/874682)
[4] www.cityscapes-dataset.com
[5] www.nuscenes.org/nuscenes
[6] arxiv.org/abs/2406.04343
[7] arxiv.org/abs/1803.10122
[8] www.researchgate.net/publication/354728319_World_model_learning_and_inference
[9] openreview.net/pdf?id=BZ5a1r-kVsf
[10] arxiv.org/pdf/2403.00504
[11] openaccess.thecvf.com/content/CVPR2024/html/Wu_4D_Gaussian_Splatting_for_R eal-Time_Dynamic_Scene_Rendering_CVPR_2024_paper.html

What is claimed is:

1. A computer-implemented method for pre-training a task head for a perception task, the method comprising the following steps:
receiving, at an input layer of the task head, a plurality of latent representations, wherein each latent representation of the plurality of latent representations is associated with a first training dataset included in a first training database, wherein each first training dataset includes optical sensor data acquired by at least one optical sensor, and wherein each first training dataset further includes a perception task label;
transforming, by one or more hidden layers of the task head, each of the plurality of received latent representations into a perception task result;
outputting, at an output layer of the task head, the perception task result for each of the plurality of received latent representations; and
pre-training weights of at least the one or more hidden layers of the task head by optimizing a task-specific loss function, wherein the optimizing of the task-specific loss function includes comparing the output perception task result with the perception task label for each of the plurality of received latent representations.

2. The method according to claim 1, further comprising the following step:
receiving, at the task-specific loss function of the task head, the perception task label associated with each of the plurality of received latent representations.

3. The method according to claim 1, wherein the at least one optical sensor includes at least one of:
a camera,
a LIDAR sensor,
a radar sensor,
an ultrasound sensor, or
a thermal sensor.

4. The method according to claim 1, wherein at least a subset of the first training datasets further includes motion sensor data and/or position sensor data and/or navigation sensor data.

5. The method according to claim 4, wherein the motion sensor data are acquired by means of a motion sensor, and/or the position sensor data and/or the navigation sensor data are acquired using a satellite-based navigation system.

6. The method according to claim 1, wherein the plurality of latent representations is obtained using a pre-trained first encoder.

7. The method according to claim 6, wherein pre-training of the first encoder to provide the pre-trained first encoder includes the following steps:
receiving, at an input layer of the first encoder, the optical sensor data included in at least a subset of each of the first training datasets;
encoding, by one or more hidden layers of the first encoder, the optical sensor data of each of the received first training datasets within the subset into a latent representation;
outputting, at an output layer of the first encoder, the latent representation;
receiving, at an input layer of a renderer, the output latent representation;
reconstructing, by one or more hidden layers of the renderer, the optical sensor data based on the received latent representation; and
pre-training weights of at least the one or more hidden layers of the first encoder by optimizing a reconstruction loss, wherein the optimizing of the reconstruction loss includes comparing the reconstructed optical sensor data with the received sensor data.

8. The method according to claim 1, wherein the pre-training of the task head is accompanied by one or more auxiliary self-supervised learning (SSL) tasks.

9. The method according to claim 6, wherein the pre-training of the first encoder is accompanied by one or more auxiliary self-supervised learning (SSL) tasks

10. The method according to claim 6, wherein at least one of:
the latent representation includes, or is supplied along with a generative model, which encodes a temporal evolution of the optical sensor data;
the first encoder, and/or any further encoder, includes, or is supplied along with a generative model, which encodes a temporal evolution of the optical sensor data; or
the task head, and/or a renderer, includes, or is supplied along with a generative model, which encodes a temporal evolution of the optical sensor data.

11. A computer-implemented method of performing a perception task, the method comprising the following steps:
receiving, at an input layer of a pre-trained second encoder, a dataset including optical sensor data acquired by at least one optical sensor;
encoding, by one or more hidden layers of the second encoder, the received optical sensor data into a latent representation;
outputting, by an output layer of the second encoder, the latent representation;
receiving, at an input layer of a task head, the output latent representation, wherein the task head is pretrained for a perception task by:
receiving, at an input layer of the task head, a plurality of latent representations, wherein each latent representation of the plurality of latent representations is associated with a first training dataset included in a first training database, wherein each first training dataset includes optical sensor data acquired by at least one optical sensor, and wherein each first training dataset further includes a perception task label,
transforming, by one or more hidden layers of the task head, each of the plurality of received latent representations into a perception task result,
outputting, at an output layer of the task head, the perception task result for each of the plurality of received latent representations, and
pre-training weights of at least the one or more hidden layers of the task head by optimizing a task-specific loss function, wherein the optimizing of the task-specific loss function includes comparing the output perception task result with the perception task label for each of the plurality of received latent representations;
transforming, by one or more hidden layers of the pre-trained task head, the received latent representation to a perception task result; and
outputting, by an output layer of the pre-trained task head, the perception task result.

12. The method according to claim 11, wherein pre-training the second encoder includes the following steps:
receiving, at the input layer of the second encoder, a plurality of second training datasets includes in a second training database, wherein each second training dataset includes optical sensor data acquired by at least one optical sensor;
encoding, by the one or more hidden layers of the second encoder, the optical sensor data of each of the received second training datasets into a latent representation;
outputting, at the output layer of the second encoder, the latent representation;
receiving, at an input layer of a renderer, the output latent representation;
reconstructing, by one or more hidden layers of the renderer, the optical sensor data based on the received latent representation; and
pre-training weights of at least the one of more hidden layers of the second encoder by optimizing a reconstruction loss, wherein the optimizing of the reconstruction loss includes comparing the reconstructed optical sensor data with the received sensor data.

13. The method according to claim 11, wherein the perception task includes at least one of:
an object detection and/or a classification, in an ego vehicle coordinate frame and/or a robot coordinate frame;
an occupancy estimation and/or a visibility estimation;
a map estimation;
an estimation of drivable areas relative to an ego vehicle;
a scene segmentation in a non-sensor specific representation;
an object tracking;
an object velocity estimation;
a depth estimation and/or a distance estimation;
an out-of-domain instance detection; or
a temporal prediction.

14. A task head for performing a perception task, the task head comprising:
an input layer, which is configured for receiving a plurality of latent representations, wherein each latent representation is associated with a first training dataset included in a first training database, wherein each first training dataset includes optical sensor data acquired by at least one optical sensor, and wherein each first training dataset further includes a perception task label;
one or more hidden layers which are configured for transforming each of the plurality of received latent representations into a perception task result;
an output layer which is configured for outputting the perception task result for each of the plurality of received latent representations;
wherein the task head is pre-trained by optimizing a task-specific loss function, wherein the optimizing of the task-specific loss function includes comparing the output perception task result with a perception task label for each of the plurality of received latent representations.

15. A neural network system for performing a perception task, the neural network system comprising:
a pre-trained second encoder, including:
an input layer, which is configured for receiving a dataset including optical sensor data acquired by at least one optical sensor,
one or more hidden layers, which are configured for encoding the received optical sensor data into a latent representation, and
an output layer, which is configured for outputting the latent representation; and
a task head, including:
an input layer, which is configured for receiving a plurality of latent representations, wherein each latent representation is associated with a first training dataset included in a first training database, wherein each first training dataset includes optical sensor data acquired by at least one optical sensor, and wherein each first training dataset further includes a perception task label,
one or more hidden layers which are configured to transform each of the plurality of received latent representations into a perception task result,
an output layer which is configured to output the perception task result for each of the plurality of received latent representations;
wherein the task head is pre-trained by optimizing a task-specific loss function, wherein the optimizing of the task-specific loss function includes comparing the output perception task result with a perception task label for each of the plurality of received latent representations
wherein:
the input layer of the task head is configured to receive the latent representation output by the second encoder,
the one or more hidden layers of the task head are configured to transform the received latent representation to a perception task result, and
the output layer of the task head is configured to output the perception task result.

16. The neural network system according to claim 15, wherein the second encoder is pre-trained by:
receiving, at the input layer of the second encoder, a plurality of second training datasets includes in a second training database, wherein each second training dataset includes optical sensor data acquired by at least one optical sensor;
encoding, by the one or more hidden layers of the second encoder, the optical sensor data of each of the received second training datasets into a latent representation;
outputting, at the output layer of the second encoder, the latent representation;
receiving, at an input layer of a renderer, the output latent representation;
reconstructing, by one or more hidden layers of the renderer, the optical sensor data based on the received latent representation; and
pre-training weights of at least the one of more hidden layers of the second encoder by optimizing a reconstruction loss, wherein the optimizing of the reconstruction loss includes comparing the reconstructed optical sensor data with the received sensor data.
